(19) United States
(12) Patent Application Publication
(10) Pub. No.: US 2021/0311353 A1
(43) Pub. Date: Oct. 7, 2021

(54) DISPLAY DEVICE, ELECTRONIC DEVICE AND COLOR FILTER SUBSTRATE

(71) Applicant: Japan Display Inc., Tokyo (JP)

(72) Inventor: Mitsutaka OKITA, Tokyo (JP)

(73) Assignee: Japan Display Inc., Tokyo (JP)

(21) Appl. No.: 17/213,297

(22) Filed: Mar. 26, 2021

(30) Foreign Application Priority Data
Apr. 3, 2020 (JP) 2020-067474

(51) Int. Cl. G02F 1/1335; G02F 1/1339

(52) U.S. Cl. CPC G02F 1/133512; G02F 1/13394; G02F 1/133514

(57) ABSTRACT

A display device includes a light shielding layer being on a first substrate, the light shielding layer having an opening; a first region including a first light transmitting portion having a first color material, a second light transmitting portion having a second coloring material, and a third light transmitting portion having a third color material; a second region being surrounded by the first region on the first substrate, the second region including a height adjusting member being in the opening of the light shielding layer; a resin layer being on the first light transmitting portion, the second light transmitting portion, the third light transmitting portion, and the height adjusting member; a second substrate facing the first substrate; and a liquid crystal layer being between the first substrate and the second substrate.

This application is based upon and claims the benefit of priority from the prior Japanese Patent Application No. 2020-67474, filed on Apr. 3, 2020, and the entire contents of which are incorporated herein by reference.

### FIELD

An embodiment of the present invention relates to a display device, an electronic device, and a color filter substrate.

### BACKGROUND

Currently, one of the most widely used display devices is a liquid crystal display device. For example, a liquid crystal display device is widely used not only for a television, but also as an interface for various electronic devices such as a computer, a tablet device, or a mobile phone.

Recently, many small portable electronic terminals are designed so that regions (frame region and peripheral region) other than a display surface are as narrow as possible in order to improve the display visibility and improve the design by increasing the display surface. This design guideline strictly limits regions required for devices that support the functions of electronic terminals such as an imaging device, a sensor, and an audio input/output device. For this reason, it has been proposed to provide a notch or an opening in a part of the display surface and place an image sensor or a sensor in it. For example, Japanese Unexamined Patent Application Publication No. 2010-15015 discloses that a light transmittance region is formed on a part of a display surface by configuring a display device so that a part of the display surface is structured or driven differently from other parts. By utilizing this light transmittance region, it is possible to arrange various elements in a position overlapping the display surface.

### SUMMARY

A display device in an embodiment according to the present invention includes a first substrate; a light shielding layer arranged on the first substrate, the light shielding layer having an opening; a first region including a first light transmitting portion having a first color material, a second light transmitting portion having a second coloring material, and a third light transmitting portion having a third color material, the first light transmitting portion, the second light transmitting portion, and the third light transmitting portion arranged in a lattice pattern through the light shielding layer on the first substrate; a second region surrounded by the first region on the first substrate, the second region including a height adjusting member arranged in the opening of the light shielding layer; a resin layer arranged on the first light transmitting portion, the second light transmitting portion, the third light transmitting portion, and the height adjusting member; a second substrate facing the first substrate; and a liquid crystal layer arranged between the first substrate and the second substrate.

An electronic equipment in an embodiment according to the present invention includes the display device and an image sensor arranged on the outside of the second substrate and overlapped the second region.

A color filter substrate in an embodiment according to the present invention includes a substrate; a first region including a first light transmitting portion having a first color material and transmitting a light in a first wavelength band, a second light transmitting portion having a second color material and transmitting a light in a second wavelength band, a third light transmitting portion having a third color material and transmitting a light in the wavelength band, the first light transmitting portion, the second light transmitting portion, and the third light transmitting portion arranged in a lattice pattern; a second region surrounded by the first region on the substrate, the second region including a height adjusting member transmitting a light in the third wavelength band; a resin layer arranged on the first light transmitting portion, the second light transmitting portion, the third light transmitting portion, and the at least one height adjusting member; wherein a first height from the substrate to a top surface of the first light transmitting portion, a second height from the substrate to a top surface of the second light transmitting portion, a third height from the substrate to a top surface of the third light transmitting portion, and a fourth height from the substrate to a top surface of the height adjusting member are equal.

### BRIEF DESCRIPTION OF THE DRAWINGS

FIG. 1 is a perspective view showing a display device according to an embodiment of the present invention;

FIG. 2 is a top view showing the display device according to an embodiment of the present invention;

FIG. 3 is an enlarged top view of a part of a display region in the display device according to an embodiment of the present invention;

FIG. 4 is a cross-sectional view showing a display region in the display device according to an embodiment of the present invention;

FIG. 5 is a cross-sectional view showing a manufacturing method of the display device according to an embodiment of the present invention;

FIG. 6 is a cross-sectional view showing a manufacturing method of the display device according to an embodiment of the present invention;

FIG. 7 is a cross-sectional view showing a manufacturing method of the display device according to an embodiment of the present invention;

FIG. 8 is a cross-sectional view showing a manufacturing method of the display device according to an embodiment of the present invention;

FIG. 9 is a cross-sectional view showing a manufacturing method of the display device according to an embodiment of the present invention;

FIG. 10 is a cross-sectional view showing a manufacturing method of the display device according to an embodiment of the present invention;

FIG. 11 is a cross-sectional view of the display device according to an embodiment of the present invention;

FIG. 12 is an enlarged top view of a part of a display region in the display device according to an embodiment of the present invention; and

FIG. 13 is a cross-sectional view showing a display region in the display device according to an embodiment of the present invention.

### DESCRIPTION OF EMBODIMENTS

Embodiments of the present invention will be described below referring to the drawings. The disclosure is merely an example, and the disclosure which those skilled in the art can easily conceive appropriate changes while maintaining the gist of the invention are naturally included in the scope of the invention. For the sake of clarity of explanation, the drawing may be schematically represented with respect to a width, a thickness, a shape, and the like of the respective portions in comparison with actual embodiments but are merely an example and do not limit the interpretation of the present invention. In this specification and each of the drawings, the same reference numerals (or reference numerals denoted by A, B, and the like) are given to the same elements as those described above referring to the preceding drawings, and detailed description thereof may be omitted as appropriate. In addition, the letters “first” and “second” to each element are convenient labels used to distinguish each element and have no further meaning unless otherwise stated.

Furthermore, in the detailed description of the present invention, in defining a positional relationship between one component and another component, the terms “above” and “below” include not only the case of being positioned directly above or below one component, but also the case of interposing another component therebetween, unless otherwise specified.

In a display panel, a liquid crystal layer is arranged between two substrates. In this case, since the liquid crystal layer is liquid, a spacer is provided to keep a distance (cell gap) between the two substrates. If pixels are not provided in a part of a display panel, pixel electrode or color filter is not arranged. Therefore, even if the spacer is arranged, the cell gap differs depending on the location, and nonuniformity of the image occurs due to the difference in the cell gap.

In view of the above problems, it is an object of an embodiment of the present invention to provide a display device having a high-display quality in which nonuniformity is suppressed.

### First Embodiment

### (1-1. Configuration of Electronic Equipment and Display Device)

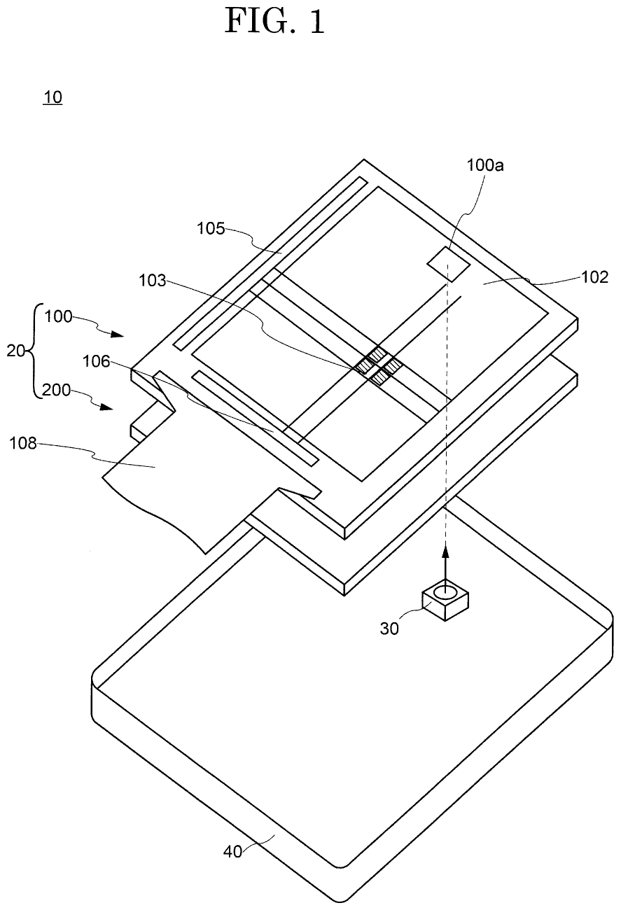

Hereinafter, an electronic equipment according to the present embodiment will be described. FIG. 1 is a perspective view showing main components of an electronic equipment 10 according to an embodiment of the present invention. The electronic equipment 10 includes a display device 20, an image sensor 30, and a housing 40. The display device 20 is configured to include a display panel 100 and a lighting device 200. The display panel 100, the lighting device 200, and the image sensor 30 are arranged to be overlapped. The display panel 100 is arranged on the front (top) side of the lighting device 200. The lighting device 200 illuminates light from the back of the display panel 100.

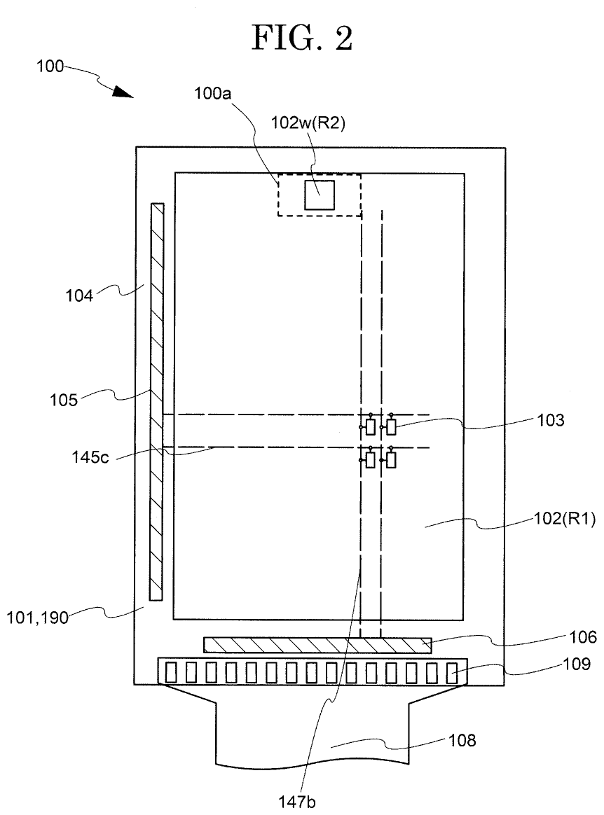

FIG. 2 is a top view of the display panel 100. The display panel 100 has a second substrate 101, a display region 102, a pixel 103, a peripheral region 104, a drive circuit 105, a drive circuit 106, a flexible printed circuit board 108, a terminal portion 109, and a first substrate 190. In the display region 102, a plurality of pixels 103 are arranged to be separated in a lattice pattern. The pixel 103 functions as a component of an image. Specifically, the pixel 103 includes a display element 130 to be described later. The display element 130 has the function of transmitting or shielding a light. The peripheral region 104 is provided so as to surround the display region 102. The drive circuit 105 is provided in the peripheral region 104 and has a function as a gate driver. The drive circuit 106 is provided in the peripheral region 104. The drive circuit 106 has a function as a source driver. A scan line 145c is connected to the drive circuit 105. A signal line 147b is connected to the drive circuit 106. The pixel 103 is connected to the scan line 145c and the signal line 147b.

In the display panel 100, a display control signal is entered into the drive circuit 105 and the drive circuit 106 via the flexible printed circuit board 108 from an external control device (not shown). In this case, scan signals from the drive circuit 105 are transmitted to the pixel 103 in the display region 102 via the scan line 145c. Similarly, video signals from the drive circuit 106 is transmitted via the signal line 147b to the pixel 103 in the display region 102. As a result, a still image and a moving image are displayed in the display region 102.

### (1-2. Configuration of Display Region and Monochromatic Display Region)

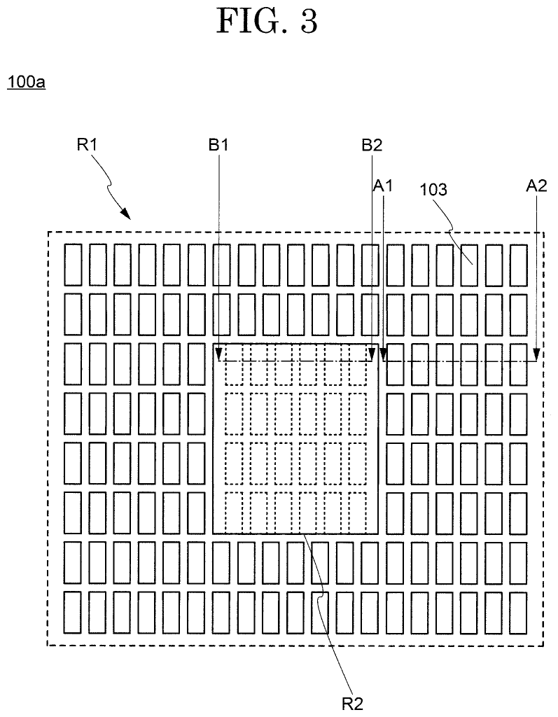

FIG. 3 is an enlarged top view of a portion 100a of the display device. As shown in FIGS. 2 and 3, the display region 102 includes an image display region R1 (also referred to as a first region) in which the pixel 103 for displaying a color image is formed, and a monochrome display region R2 (also referred to as a second region) for displaying a monochrome image. The monochromatic display region R2 is arranged in a part of the display region. Therefore, the monochrome display region R2 is surrounded by the image display region R1. In the present embodiment, no color filter is arranged in the monochromatic display region R2. The monochromatic display region R2 transmits light from the lighting device 200 arranged on the back side. The monochromatic display region R2 is a region that displays only shade of white and black. The monochromatic display region R2 has a square region with a length of 1 mm or more and 10 mm or less on one side. In this example, the monochromatic display region R2 has a square region with a side length of 5 mm. The monochromatic display region R2 is not limited to squares. For example, the monochromatic display region R2 may have a circular or elliptical region with the diameter of 1 mm or more and 10 mm or less. In this example, all four sides of the monochromatic display region R2 are surrounded by the image display region R1, but at least one side may be adjacent to each other via a light shielding region.

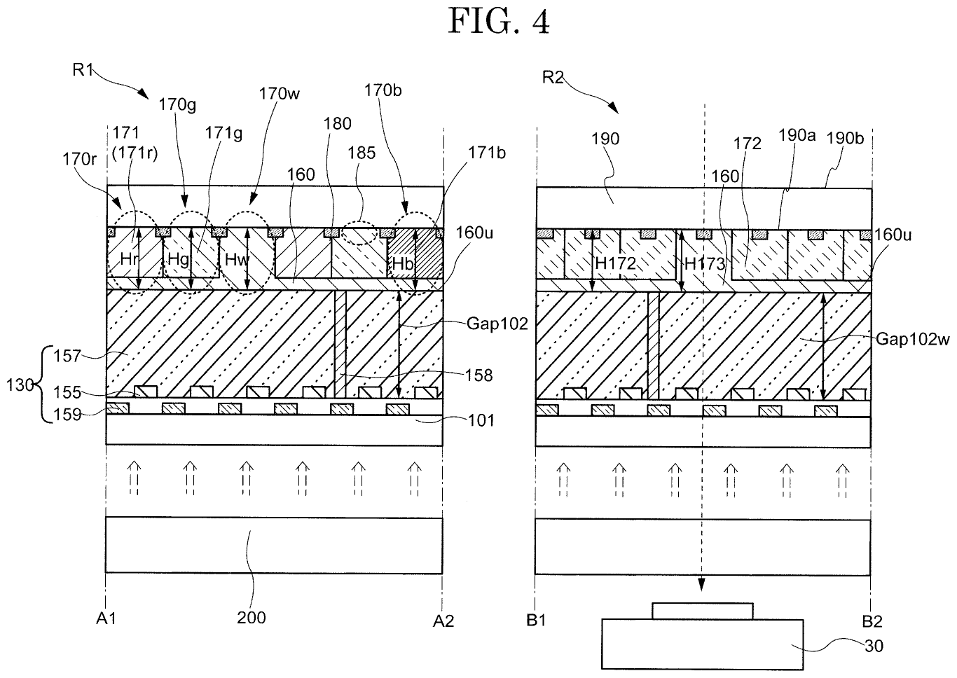

FIG. 4 is a cross-sectional view between A1-A2 of the image display region R1 and a cross-sectional view between B1-B2 of the monochromatic display region R2. The cross-sectional view in FIG. 4 is a cross-sectional view along the extending direction of a gate line. As shown in FIG. 4, in the image display region R1 (the first region), the display panel 100 includes the second substrate 101, a display element (a pixel electrode 155, a liquid crystal layer 157, a common electrode 159), a spacer 158, a resin layer 160, a color material (color filter) 171, a light shielding layer 180, and the first substrate 190.

A configuration in which the spacer 158, the resin layer 160, the color material 171, the light shielding layer 180, and a height adjusting member 172 are formed on the first substrate 190 in the display panel 100 can be referred to as a color filter substrate.

The second substrate 101 and the first substrate 190 are arranged to face each other. The second substrate 101 and the first substrate 190 has a function of transmitting light. For example, the second substrate 101 and the first substrate 190 may be made of an inorganic insulating material, an organic insulating material, or a mixed material of an inorganic insulating material and an organic insulating material having light transmittance. Specifically, a glass substrate is used for the second substrate 101 and the first substrate 190. Preferably, the second substrate 101 and the first substrate 190 are thick enough to have rigidity. Specifically, the thickness of the second substrate 101 and the first substrate 190 is preferably 100 μm or more and 1000 μm or less.

Although the second substrate 101 and the first substrate 190 are described as having a rigidity, the present invention is not limited thereto. For example, the second substrate 101 and the first substrate 190 may have a flexibility. In this case, an organic resin material may be used for the second substrate 101 and the first substrate 190. Specifically, a polyimide resin may be used for the second substrate 101 and the first substrate 190.

A transistor, a capacitive element, a wiring, and the like are provided in the second substrate 101. Details are described below.

The display element 130A include a pixel electrode 155, a liquid crystal layer 157 and a common electrode 159. That is, the display element 130 can be said to be a liquid crystal element. The display element 130 has a function of transmitting or blocking a light emitted by the lighting device 200 to the first substrate 190 side. Although not described in this embodiment, an orientation film may be provided between the pixel electrode 155 and the liquid crystal layer 157, and between the resin layer 160 and the liquid crystal layer 157.

The pixel electrode 155 is provided on the second substrate 101 (specifically, on a first surface 101a sides of the second substrate 101) for each pixel 103. The pixel electrode 155 has a function as a first electrode of the display element 130. A conductive material having a light transmittance is used for the pixel electrode 155. For example, an oxide conductive material such as ITO (Indium Zinc Oxide) and IZO (Indium Zinc Oxide) is used for the pixel electrode 155.

The common electrode 159 is provided on the second substrate 101. The common electrode 159 functions as a second electrode in the display element 130. The common electrode 159 is provided so as to overlap a plurality of pixel electrodes 155 for each pixel 103, as will be briefly described in FIG. 4 and described in detail later. The common electrode 159 includes a material having light transmittance and conductivity. For example, an oxide conductive material such as ITO and IZO is used for the common electrode 159.

The liquid crystal layer 157 is arranged between the pixel electrode 155 (or an insulating layer 154) and the resin layer 160. That is, the liquid crystal layer 157 is provided between the second substrate 101 and the first substrate 190. The liquid crystal layer 157 may be made of any suitable liquid crystal material. In this example, a liquid crystal element of IPS (In Plane Switching) system is used as the display element 130. TN (Twist Nematic) liquid crystal element or VA (Vertical Alignment) liquid crystal element may be used.

A plurality of spacers 158 are provided in the liquid crystal layer 157. The spacers 158 have the function of keeping the distance between the pixel electrode 155 (or the insulating layer 154) and the resin layer 160, that is, the interval between the second substrate 101 and the first substrate 190. An inorganic material or an organic material is used for the spacer 158. In this example, a photo spacer formed of a silicon oxide or a photosensitive resin is used for the spacer 158.

The light shielding layer 180 is provided on the first substrate 190 (specifically, a first surface 190a side of the first substrate 190). The light shielding layer 180 has an opening 185 in a lattice pattern. The light shielding layer 180 has the function of blocking light from being irradiated to the first substrate 190 sides. The light shielding layer 180 includes a non-light transmittance resin material. For example, a black resin material (e.g., polyimide) is used for the light shielding layer 180.

The color material 171 is provided on the first substrate 190 and on the opening 185 of the light shielding layer 180. The color material 171 has a function of transmitting light in a specific wavelength band. For example, a material that transmits light in a red wavelength band (also referred to as a first wavelength band, specifically, a wavelength band of 610 nm to 750 nm) is used as a color material 171r. As a color material 171g, a material that transmits light in a green wavelength band (also referred to as a second wavelength band, specifically, a wavelength band of 500 nm to 560 nm) is used. As a color material 171b, a material that transmits light in a blue wavelength band (specifically, a wavelength band of 435 nm to 480 nm) is used.

In the present embodiment, a portion where the color material 171r is arranged, and transmits light in the red wavelength band is referred to as a red light transmitting portion 170r (also referred to as a first light transmitting portion). The portion where the color material 171g is arranged and transmits light in the green wavelength band is referred to as a green light transmitting portion 170g (also referred to as a second light transmitting portion). The portion where the color material 171b is arranged and transmits light in the blue wavelength band is referred to as a blue light transmitting portion 170b.

In this example, only the resin layer 160 is arranged in a portion where the color material 171 is not arranged. The resin layer 160 transmits white light (also referred to as light in a third wavelength band) including all light in the visible-light wavelength band (specifically, 380 nm to 750 nm) due to the use of a colorless and transparent material. Therefore, this region is referred to as a white light transmitting portion 170w (a third light transmitting portion).

The red light transmitting portion 170r, the green light transmitting portion 170g, the blue light transmitting portion 170b, and the white light transmitting portion 170w correspond to the pixel 103 in FIG. 2.

The resin layer 160 is provided on the color material 171 and the light shielding layer 180. For the resin layer 160 (also referred to as an overcoat layer), a colorless transparent organic material or a composite material of a colorless transparent organic material and a colorless transparent inorganic material is used. For example, an acrylic resin is used for the resin layer 160.

In the present embodiment, as described above, the red light transmitting portion 170r, the green light transmitting portion 170g, the blue light transmitting portion 170b, and the white light transmitting portion 170w can be arranged in a lattice pattern via the light shielding layer 180. In the present embodiment, the color material 171r, the color material 171g, and the color material 171b are provided in contact with each other, but they may be arranged apart with a distance between them.

On the other hand, in the monochromatic display region R2, the height adjusting member 172 is provided instead of the color member 171 in the above-described configuration. In the monochromatic display region R2, the image sensor 30 is provided on the outside of the second substrate 101. In other words, the monochromatic display region R2 of the display device 20 and the image sensor 30 overlap when viewed from the top. Therefore, the image sensor 30 receives a light that enters through the monochromatic display region R2.

The height adjusting member 172 is arranged in a dotted pattern in the monochromatic display region R2. In this example, similar to the color material 171 arranged in the display region 102, a plurality of height adjusting members 172 are provided in a lattice pattern. The height adjusting member 172 may be provided so as to overlap the light shielding layer 180.

In this case, the height adjusting member 172 is provided at a density approximately equal to the density at which the color material 171 is arranged. That is, patterns of the same shapes are successively provided from the display region 102 to the monochromatic display region R2.

A material that transmits white light is used for the height adjusting member 172. The height adjusting member 172 may include a material that differs from the resin layer 160. For example, an organic resin containing a photosensitive material (specifically, an acrylic resin) is used for the height adjusting member 172.

In the monochromatic display region R2, the plurality of spacers 158 are provided in the same manner as the display region 102. Specifically, the density of the spacer 158 in the image display region R1 and the density of the spacer 158 in the monochromatic display region R2 are substantially the same. In this case, it is preferable that the spacer 158 and the light shielding layer 180 overlap with each other. As a result, it is possible to prevent the orientation failure of liquid crystal molecules 157a in the liquid crystal layer 157 from being visually recognized in the vicinity of the spacer 158.

In the present embodiment, the height from the first substrate 190 to an upper surface 160u of the resin layer 160 in the red light transmitting portion 170r is defined as a height Hr (also referred to as a first height). Similarly, the height from the first substrate 190 to the upper surface 160u of the resin layer 160 in the green light transmitting portion 170g is defined as a height Hg (also referred to as a second height). Similarly, the height from the first substrate 190 to the upper surface 160u of the resin layer 160 in the blue light transmitting portion 170b is defined as the height Hb. Similarly, the height from the first substrate 190 to the upper surface 160u of the resin layer 160 in the white light transmitting portion 170w is defined as a third height Hw (also referred to as a third height). Similarly, the height from the first substrate 190 to the upper surface 160u of the resin layer 160 on the height adjusting member 172 is defined as a height H172 (also referred to as a fourth height). The height from the first substrate 190 to the upper surface 160u of the resin layer 160 of a region 173 where the height adjusting member 172 is not provided is defined as a height H173.

In the present embodiment, the height Hr, the height Hg, the height Hb, the height Hw, the height H172, and the height H173 are equal. As a result, a cell gap Gap102 in the image display region R1 and a cell gap Gap102w in the monochromatic display region R2 become equal. In this case, substantially the same cell gaps can be ensured in the entire display region 102. Therefore, display unevenness of an image due to a difference of the cell gap can be suppressed. Therefore, by using the present embodiment, it is possible to provide a display device having a high display quality in which display unevenness is suppressed.

### (1-3. Manufacturing Methods of Display Device)

Next, a manufacturing method of the display device 20 will be described referring to the drawings. Specifically, a manufacturing method of the color filter substrate (up to forming the resin layer 160 on the first substrate 190) used in the display panel 100 will be described.

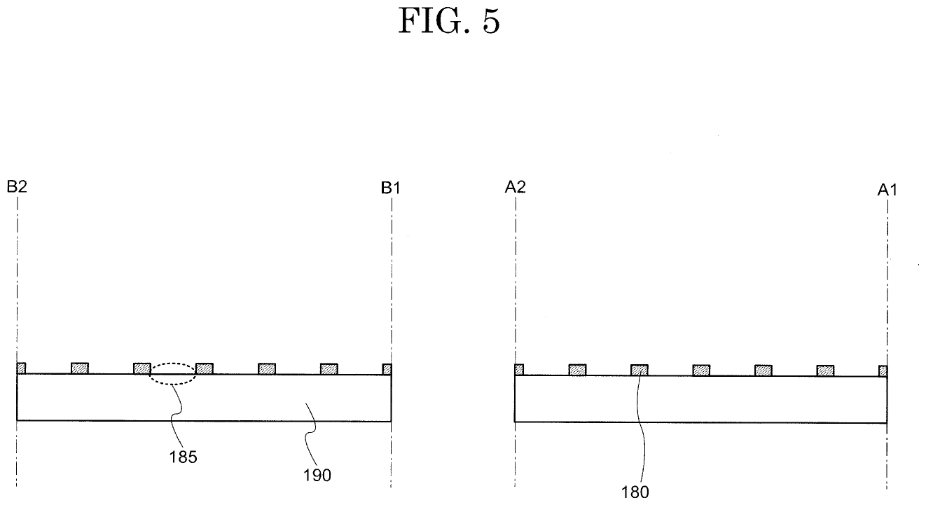

First, as shown in FIG. 5, the light shielding layer 180 is formed on the first substrate 190. As a black resin material having a photosensitive material, a polyimide resin, an acrylic resin, an epoxy resin, or the like is used for the light shielding layer 180. The light shielding layer 180 is processed into a predetermined shape by a photolithography method after being coated and formed by a slit coating method. At this time, the opening 185 is formed.

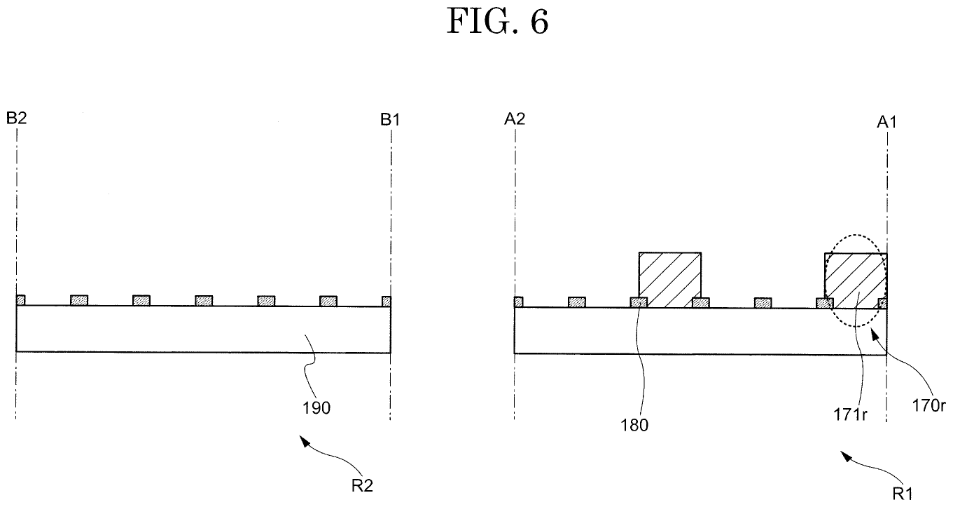

Next, as shown in FIG. 6, the red color material (color filter) 171r is formed on the first substrate 190 (the opening 185 of the light shielding layer 180) and the light shielding layer 180. In this case, the red color material 171r is coated and formed on the entire top surface of the first substrate 190 by the slit coating method, and then processed by the photolithography method so as to be arranged at a predetermined position. The thickness of the red color material 171r is 1 μm or more and 10 μm or less, preferably 1 μm or more and 5 μm or less. In this example, the thickness of the red color material 171r is 2.5 μm.

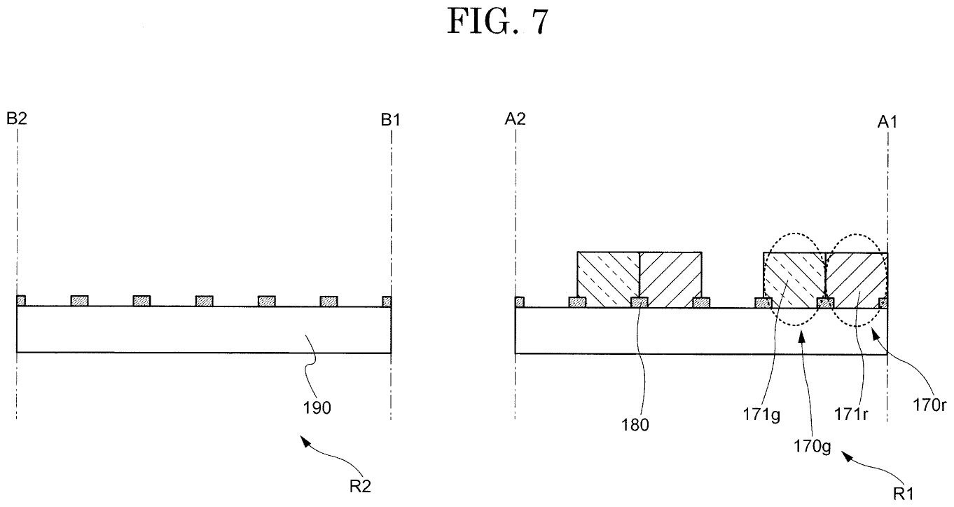

Next, as shown in FIG. 7, the green color material (color filter) 171g is formed on the first substrate 190 (the opening 185 of the light shielding layer 180) and the light shielding layer 180. In this case, the green color material 171g is coated and formed on the first substrate 190, the light shielding layer 180, and the red color material 171r by the slit coating method, and then processed by the photolithography method so as to be arranged at a position different from the red color material 171r.

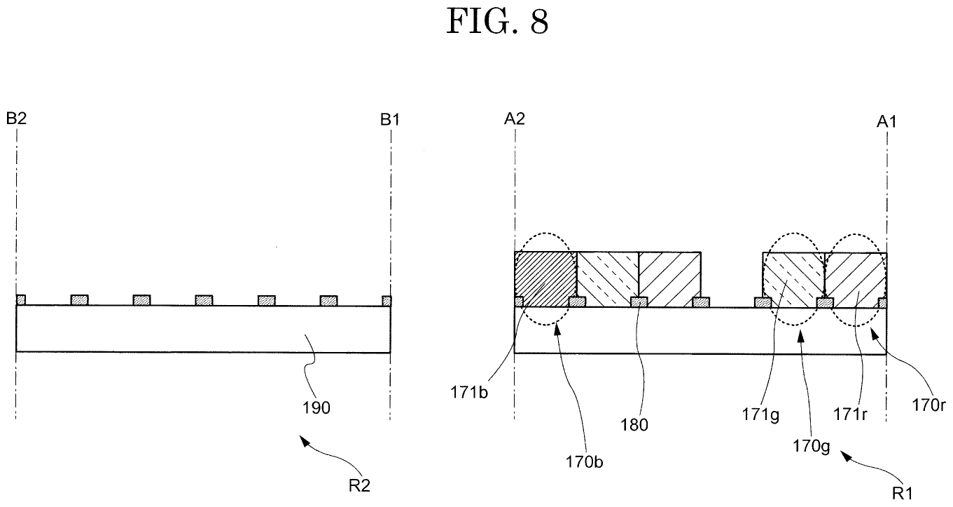

Next, as shown in FIG. 8, the blue color material (color filter) 171b is formed on the first substrate 190 (the opening 185 of the light shielding layer 180) and the light shielding layer 180. In this case, the blue color material 171b is coated and formed on the first substrate 190, the light shielding layer 180, the red color material 171r, and the green color material 171g by the slit coating method, and then processed by the photolithography method so as to be arranged at a position different from the red color material 171r and the green color material 171g.

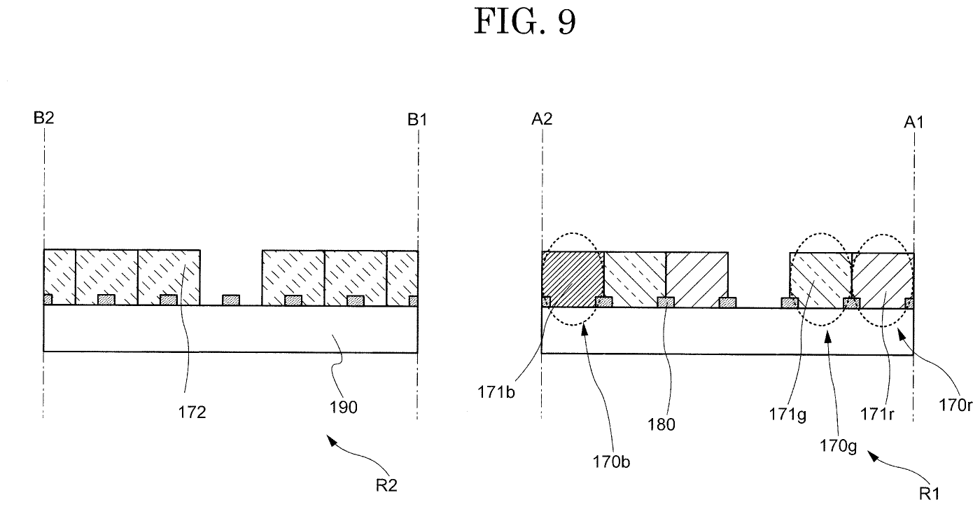

Next, as shown in FIG. 9, the height adjusting member 172 will be formed on the first substrate 190. A transparent material containing a photosensitive material is used for the height adjusting member 172. For example, in addition to an acrylic resin, an epoxy resin, a polyimide resin, or the like is used for the height adjusting member 172. In this case, the height adjusting member 172 is coated and formed on the first substrate 190, the light shielding layer 180, the red color material 171r, the green color material 171g, and the blue color material 171b by the slit coating method, and then processed so as to be arranged only in the monochromatic display region R2 by the photolithography method. In this case, the height adjusting member 172 may be arranged so as to cover the light shielding layer 180 which is interspersed and arranged. The height adjusting member 172 is formed to have the same thickness as the red color material 171r, the green color material 171g, and the blue color material 171b.

In this case, the height adjusting member 172 may be arranged at the same pitch with the color material 171 provided in the display region 102 in the extending direction of the gate line. Therefore, in the monochromatic display region R2, the height adjusting member 172 is provided at a position corresponding to the red color material 171r, the green color material 171g, and the blue color material 171b of the image display region R1. That is, the pitch at which the red light transmitting portion 170r, the green light transmitting portion 170g, the blue light transmitting portion 170b, and the white light transmitting portion 170w are provided may be the same as the pitch at which the height adjusting member 172 of the monochromatic display region R2 is provided.

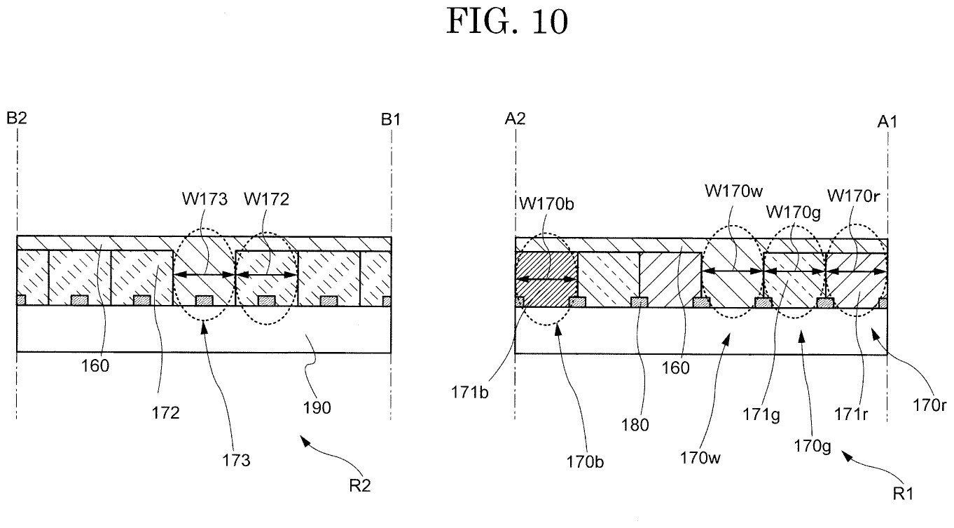

Next, as shown in FIG. 10, the resin layer 160 is formed on the first substrate 190, the red color material 171r, the green color material 171g, the blue color material 171b, and the height adjusting member 172. The resin layer 160 is formed by a coating method, specifically, a slit coating method. The thickness of the resin layer 160 is 0.5 μm or more and 10 μm or less, preferably 1 μm or more and 3 μm or less. In this example, the thickness of the resin layer 160 is 1 μm.

At this time, a width W170w of the white light transmitting portion 170w in the display region 102, a width W170r of the red light transmitting portion 170r, a width W170g of the green light transmitting portion 170g, and a width W170b of the blue light transmitting portion 170b, and a width W172 of the height adjusting member 172 in the monochromatic display region R2 and a width W173 of the region 173 in which the height adjusting member 172 is not provided are equal (or substantially equal) and have narrow pitches (intervals). For example, a pitch of a panel for automotive is about 60 μm, and a pitch of a panel for mobile devices is about 20 μm. Thus, when the resin layer 160 is formed, the top surface of the resin layer 160 is planarized regardless of whether it is a region the color material 171 of each color or the height adjusting member 172 is provided or not provided.

Therefore, as shown in FIG. 3, the height Hr from the first substrate 190 to the top surface 160u of the resin layer 160 in the red light transmitting portion 170r, the height Hg from the first substrate 190 to the top surface 160u of the resin layer 160 in the green light transmitting portion 170g, the height Hb from the first substrate 190 to the top surface 160u of the resin layer 160 in the blue light transmitting portion 170b, the height Hw from the first substrate 190 to the top surface 160u of the resin layer 160 in the white light transmitting portion 170w, the height H172 from the first substrate 190 to the top surface 160u of the resin layer 160 on the height adjusting member 172, and the height H173 from the first substrate 190 to the top surface 160u of the resin layer 160 on the region 173 in which the height adjusting member 172 does not exist are equal or substantially equal.

### (1-4. Other Configurations of Display Device)

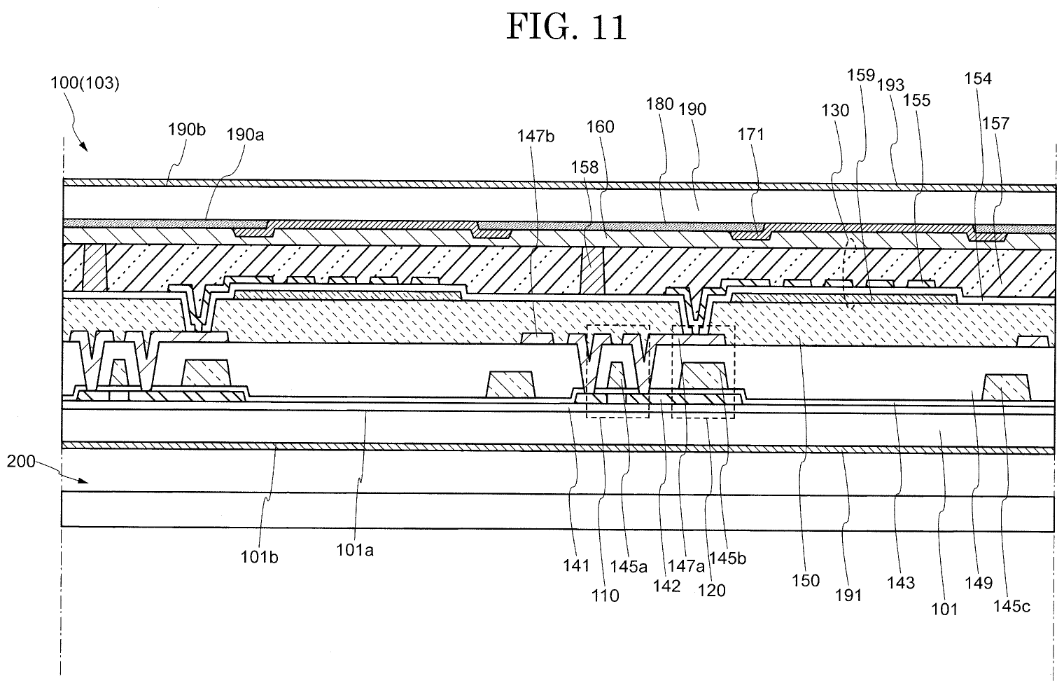

Next, the configuration of the display device 20 will be described in detail using a cross-sectional view. FIG. 11 shows a cross-sectional view of the display device 20, particularly the pixel 103 provided in the display region 102 of the display panel 100. As shown in FIG. 11, the pixel 103 of the display panel 100 includes a transistor 110, a capacitive element 120, insulating layer 141, an insulating layer 149, a planarization layer 150, a polarizer 191, and a polarizer 193 in addition to second substrate 101, the display element 130 (the pixel electrode 155, the liquid crystal layer 157, the common electrode 159), the spacer 158, the resin layer 160, the color material 171, the light shielding layer 180, and the first substrate 190.

The transistor 110 has a semiconductor layer 142, a gate insulating layer 143, a gate electrode 145a, and a source-drain electrode 147a. The transistor 110 has a top-gate/top-contact structure, but is not limited thereto, and may have a bottom-gate structure or may have a bottom-contact structure.

The capacitive element 120 includes a source or drain region and a capacitance electrode 145b of the semiconductor layer 142 with the gate insulating layer 143 as a dielectric.

The planarization layer 150 serves as a planarization film. The planarization layer 150 is provided on the insulating layer 149. The planarization layer 150 includes an organic resin. In this example, an acrylic resin is used for the planarization layer 150. The planarization layer 150 may be formed of an epoxy-resin, a polyimide resin, a polyamide resin, a polystyrene resin, a polyethylene resin, a polyethylene terephthalate resin or the like. The planarization layer 150 may be formed of a stacked layer of an organic resin and an inorganic material.

The insulating layer 141 is provided on the second substrate 101 and has a function as a base film. As a result, it is possible to prevent the impurity, typically alkaline metal, water, hydrogen, or the like from being diffused from the second substrate 101 to the semiconductor layer 142.

The semiconductor layer 142 is provided on the insulating layer 141. The semiconductor layer 142 may be formed of a silicone, an oxide semiconductor, or an organic semiconductor, or the like.

The gate insulating layer 143 is provided on the insulating layer 141 and the semiconductor layer 142. The gate insulating layer 143 may be formed of a silicon oxide, a silicon oxynitride, a silicon nitride, or another high dielectric constant inorganic material.

The gate electrode 145a is provided on the gate insulating layer 143. The gate electrode 145a is connected to the scan line 145c as appropriate. The gate electrode 145a and the capacitance electrode 145b are also provided on the gate insulating layer 143. The gate electrode 145a and the capacitance electrode 145b may be a single-layer structure of the above-described conductive materials or may be a stacked structure. The gate electrode 145a, the capacitance electrode 145b, and the scan line 145c are formed of conductive materials selected from tantalum, tungsten, titanium, molybdenum, aluminum, and the like.

The insulating layer 149 is formed of a material similar to the gate insulating layer 143. The insulating layer 149 is provided on the gate insulating layer 143, the gate electrode 145a, and the capacitance electrode 145b. The insulating layer 149 may be a single layer or a stacked structure of the above materials.

The source-drain electrode 147a is provided on the insulating layer 149. The source-drain electrode 147a is connected to the signal line 147b as appropriate. The source-drain electrode 147a and the signal line 147b may be formed of materials similar to those listed as examples of materials of the gate electrode 145a. In this case, the source-drain electrode 147a may be formed of the same material as that of the gate electrode 145a or different material from that of the gate electrode 145a.

A conductive layer 153 is provided on the planarization layer 150. The conductive layer 153 may be formed of a material having light transmittance. For example, the conductive layer 153 may be formed of an oxide conductive material such as ITO or IZO. In addition to the conductive layer 153, other wirings (not specifically shown) bonded to the source-drain electrode 147a are also formed using the same conductive materials.

The insulating layer 154 is provided on the planarization layer 150 and the conductive layer 153. The insulating layer 154 is formed of a material similar to the gate insulating layer 143.

The polarizer 191 is provided on a second surface 101b of the outside of the second substrate 101. The polarizer 193 is provided on a second surface 190b of the outside (visually recognized side) of the first substrate 190.

### Second Embodiment

In the present embodiment, a display device different from the first embodiment will be described. Specifically, a display device including a boundary region provided between the image display region and the monochromatic display region will be described.

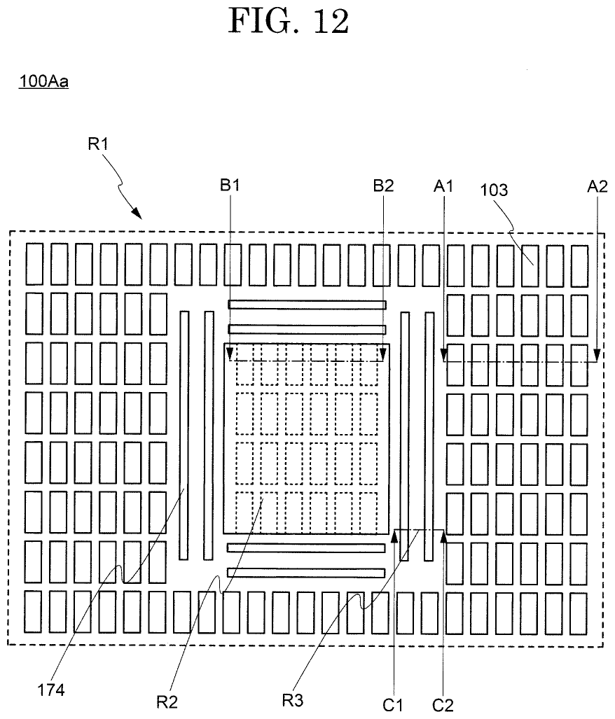

FIG. 12 shows an enlarged top view of some region 100Aa of a display panel 100A. As shown in FIG. 12, in the present embodiment, a boundary region R3 (also referred to as a third region) may be provided between the image display region R1 and the monochromatic display region R2 in the region 100Aa. In this example, the boundary region R3 includes a width corresponding to one to two pixels, but may include a width corresponding to a larger number of pixels.

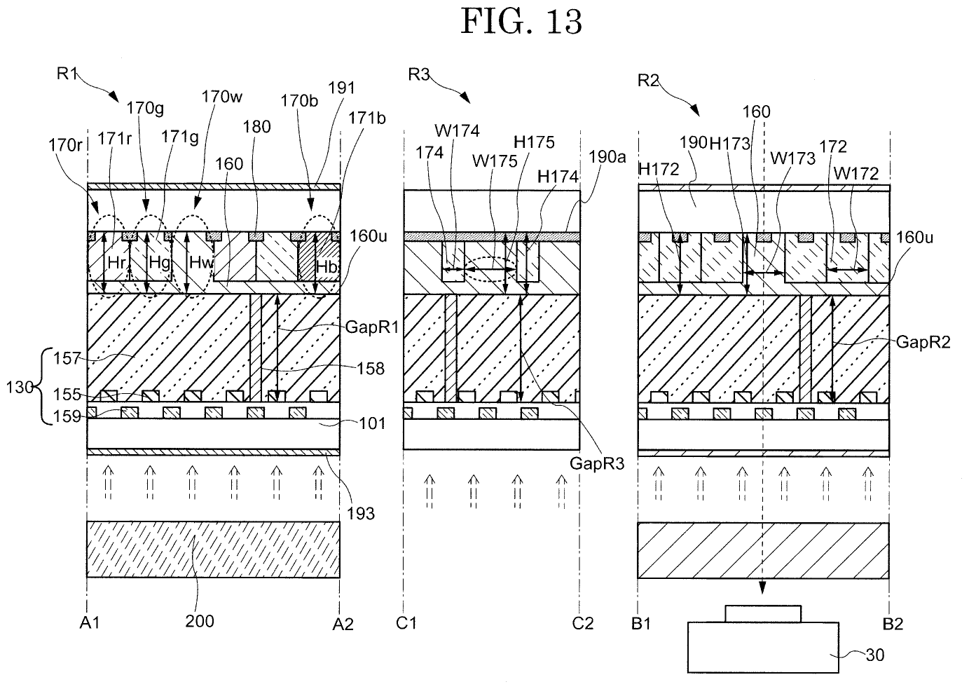

FIG. 13 shows a cross-sectional view between A1-A2 of the image display region R1, a cross-sectional view between B1-B2 of the monochromatic display region R2, and a cross-sectional view between C1-C2 of the boundary region R3.

As shown in FIG. 13, in the boundary region R3, the display panel 100 includes the second substrate 101, the display element (the pixel electrode 155, the liquid crystal layer 157, the common electrode 159), the spacer 158, the resin layer 160, the light shielding layer 180, and the first substrate 190, and includes a height adjusting member 174 instead of the color material 171.

In the boundary region R3, the light shielding layer 180 is provided on the entire surface of the first surface 190a of the first substrate 190.

A plurality of height adjusting members 174 are provided on the light shielding layer 180. The plurality of height adjusting members 174 are provided apart from each other. The shape of the height adjusting member 174 is provided in a band shape when viewed from the top in this example, the present invention is not particularly limited. A width W174 of the height adjusting member 174 may be narrower than the width W172 of the height adjusting member 172. A width W175 of a space 175 between the two height adjustment members 174 may be larger than the width W173 of the region 173 in which the height adjusting member 172 is not provided in the monochromatic display region R2.

In the boundary region R3, the height adjusting member 174 is provided on the light shielding layer 180. The thickness of the resin layer 160 formed in the boundary region R3 can be controlled to be smaller than that of the monochromatic display region R2 by having the above configuration.

The height from the first substrate 190 to the top surface 160u of the resin layer 160 on the height adjusting member 174 is referred to as a height H174 (also referred to as a fifth height). In this embodiment, the height Hr (the first height) from the first substrate 190 to the top surface 160u of the resin layer 160 in the red light transmitting portion 170r, the height Hg (the second height) from the first substrate 190 to the top surface 160u of the resin layer 160 in the green light transmitting portion 170g, the height Hb from the first substrate 190 to the top surface 160u of the resin layer 160 in the blue light transmitting portion 170b, the height Hw (the third height) from the first substrate 190 to the top surface 160u of the resin layer 160 in the white light transmitting portion 170w, the height H172 (the fourth height) from the first substrate 190 to the top surface 160u of the resin layer 160 on the height adjusting member 172, the height H174 (the fifth height) from the first substrate 190 to the top surface 160u of the resin layer 160 on the region 173, and the height H175 from the first substrate 190 to the top surface 160u on the 175 are equal.

As a result, a cell gap GapR1 in the image display region R1, a cell gap GapR2 in the monochromatic display region R2, and a cell gap GapR3 in the boundary region R3 become equal, and substantially the same cell gap can be ensured in the entire display region 102. Therefore, it is possible to suppress the occurrence of unevenness due to the difference in the cell gap. Therefore, by using the present embodiment, it is possible to provide a display device having a high display quality in which display unevenness is suppressed.

The height adjusting member 174 is formed of a material that transmits white light. The height adjusting member 174 may include the same material as that of the height adjusting member 172, or the same material as that of the color material of each color. For example, the height adjusting member 172 may be formed of an organic resin containing a photosensitive material (specifically, an acrylic resin).

In the present embodiment, the lighting device 200 corresponding to the image display region R1 and the lighting device 200 corresponding to the monochromatic display region R2 may be different from each other. Similarly, the member used for the polarizer 191 and the polarizer 193 in the image display region R1 and the member used for the polarizer 191 and the polarizer 193 in the monochromatic display region R2 may be different from each other.

In the present embodiment, by having the boundary region R3, it is possible to hide a display defect caused by a difference in the lighting device and the polarizer between the image display region R1 and the monochromatic display region R2. Therefore, it is possible to enhance the function of the display region and the function of the monochromatic display region and to provide a display device having a high-display quality.

What is claimed is:

1. A display device comprising;
a first substrate;
a light shielding layer arranged on the first substrate, the light shielding layer having an opening;
a first region including a first light transmitting portion having a first color material, a second light transmitting portion having a second color material, and a third light transmitting portion having a third color material, the first light transmitting portion, the second light transmitting portion, and the third light transmitting portion being arranged in a lattice pattern through the light-shielding layer on the first substrate;
a second region being surrounded by the first region on the first substrate, the second region including at least one height adjusting member being arranged in the opening of the light shielding layer;
a resin layer being arranged on the first light transmitting portion, the second light transmitting portion, the third light transmitting portion, and the at least one height adjusting member;
a second substrate facing the first substrate, and
a liquid crystal layer being arranged between the first substrate and the second substrate.

2. The display device according to claim 1, wherein
a first height from the first substrate to a top surface of the resin layer in the first light transmitting portion, a second height from the first substrate to the top surface of the resin layer in the second light transmitting portion, a third height from the first substrate to the top surface of the resin layer in the third light transmitting portion; and a fourth height from the first substrate to the top surface of the resin layer on the at least one height adjusting member are equal.

3. The display device according to claim 2, wherein
the at least one height adjusting member includes a plurality of height adjusting members, and
the pitch at which the first light transmitting portion, the second light transmitting portion, and the third light transmitting portion are provided is the same as the pitch at which the plurality of height adjusting members are provided.

4. The display device according to claim 1, further comprising:
a third region being arranged between the first region and the second region, wherein
the light shielding layer is arranged on the entire surface of the third region in the first substrate,
the third region includes at least one second height adjusting member arranged on the light shielding layer,
a first height from the first substrate to a top surface of the resin layer in the first light transmitting portion, a second height from the first substrate to the top surface of the resin layer in the second light transmitting portion, a third height from the first substrate to the top surface of the resin layer in the third light transmitting portion, and a fourth height from the first substrate to the top surface of the resin layer in the at least one height adjusting member and a fifth height from the first substrate to the top surface of the resin layer in the at least one second height adjusting member are equal.

5. The display device according to claim 4, wherein
the at least one second height adjusting member includes a plurality of second height adjusting members, and
the plurality of second height adjusting members are separated from each other.

6. The display device according to claim 1, further comprising:
a plurality of spacers maintaining the distance between the first and second substrates, wherein
the light shielding layer includes a plurality of apertures in the second region, and
the plurality of spacers are overlapped on the light shielding layer.

7. The display device according to claim 1, wherein
the height adjusting member includes a different material from the resin layer.

8. The display device according to claim 1, wherein
the first region includes a fourth light transmitting portion transmitting white light.

9. An electronic device comprising:
the display device according to claim 1; and
an image sensor being arranged on the outside of the second substrate and overlapped on the second area.

10. A color filter substrate comprising:
a substrate;
a first region including:
a first light transmitting portion having a first color material and transmitting a light in a first wavelength band,
a second light transmitting portion having a second color material and transmitting a light in a second wavelength band; and
a third light transmitting portion having a third color material and transmitting a light in a third wavelength band, the first light transmitting portion, the second light transmitting portion, and the third light transmitting portion being arranged in a lattice pattern;
a second region being surrounded by the first region on the substrate, the second region including at least one height adjusting member transmitting a light in the third wavelength band; and
a resin layer being arranged on the first light transmitting portion, the second light transmitting portion, the third light transmitting portion, and the at least one height adjusting member,
wherein a first height from the substrate to a top surface of the first light transmitting portion, a second height from the substrate to a top surface of the second light transmitting portion, a third height from the substrate to a top surface of the third light transmitting portion; and a fourth height from the substrate to a top surface of the resin layer on the at least one height adjusting member are equal.
